(19) United States
(12) Patent Application Publication
(10) Pub. No.: US 2024/0110878 A1
(43) Pub. Date: Apr. 4, 2024

(54) INTEGRATED FLUID LEAK DETECTION USING MULTIPLE SENSORS

(71) Applicant: Chevron U.S.A. Inc., San Ramon, CA (US)

(72) Inventors: Nikolaos Ioannis Salmatanis, Cypress, TX (US); Tyrone Jenkins, Sugar Land, TX (US); Larry A. Bowden, JR., Houston, TX (US)

(21) Appl. No.: 18/479,566

(22) Filed: Oct. 2, 2023

Related U.S. Application Data
(60) Provisional application No. 63/413,126, filed on Oct. 4, 2022.

(51) Int. Cl. G01N 21/88

(52) U.S. Cl. CPC G01N 21/8851; G01N 2021/8877; G01N 2021/8887

(57) ABSTRACT

Fluid leak observations made by different types of sensors are combined to detect fluid leaks at a fluid facility. Separate fluid leak observations made by different types of sensors are reconciled using a Bayesian model. The Bayesian model outputs likelihoods of different fluid leak probabilities, and the likelihoods of different fluid leak probabilities are used to facilitate operations at the fluid facility.

### CROSS-REFERENCE TO RELATED APPLICATION

The present application claims the benefit of U.S. Provisional Application No. 63/413,126, entitled “Integrated Fluid Leak Detection Using Multiple Sensors,” which was filed on Oct. 4, 2022, the entirety of which is hereby incorporated herein by reference.

### FIELD

The present disclosure relates generally to the field of detecting fluid leaks using multiple sensors of different types.

### BACKGROUND

Leaks at fluid facilities may cause equipment failure and loss of fluid. Leak detection technologies may be prone to error, costly, and/or not integrated into a single solution.

### SUMMARY

This disclosure relates to detecting fluid leaks. Multi-sensor information and/or other information may be obtained. The multi-sensor information may characterize separate fluid leak probability levels detected at a location by multiple sensors of different types for a fluid facility. The multiple sensors of the different types may include a first sensor of a first type, a second sensor of a second type different from the first type, and/or other sensors of other types. The muti-sensor information may characterize a first fluid leak probability level detected at the location by the first sensor of the first type, a second fluid leak probability level detected at the location by the second sensor of the second type, and/or other fluid leak probability levels detected at the location by sensors of other types. Different fluid leak probability levels detected by different ones of the multiple sensors may be reconciled using a Bayesian model. The Bayesian model may determine likelihoods of multiple fluid leak probability levels at the location based on the separate fluid leak probability levels detected at the location by the multiple sensors and/or other information. One or more operations at the fluid facility may be facilitated based on the likelihoods of the multiple fluid leak probability levels at the location and/or other information.

A system for detecting fluid leaks may include one or more electronic storage, one or more processors and/or other components. The electronic storage may store multi-sensor information, information relating to sensors, information relating to sensor types, information relating to a fluid facility, information relating to a location at the fluid facility, information relating to fluid, information relating to fluid leaks, information relating to operations at the fluid facility, and/or other information.

The processor(s) may be configured by machine-readable instructions. Executing the machine-readable instructions may cause the processor(s) to facilitate detecting fluid leaks. The machine-readable instructions may include one or more computer program components. The computer program components may include one or more of a sensor component, a reconciliation component, an operation component, and/or other computer program components.

The sensor component may be configured to obtain multi-sensor information and/or other information. The multi-sensor information may characterize separate fluid leak probability levels detected at a location by multiple sensors of different types for a fluid facility. The multiple sensors of the different types may include a first sensor of a first type, a second sensor of a second type different from the first type, and/or other sensors of other types. The muti-sensor information may characterize a first fluid leak probability level detected at the location by the first sensor of the first type, a second fluid leak probability level detected at the location by the second sensor of the second type, and/or other fluid leak probability levels detected at the location by sensors of other types.

In some implementations, the fluid leak may include a gas leak and/or a liquid leak.

In some implementations, the separate fluid leak probability levels detected at the location by the multiple sensors may include a first fluid leak probability level, a second fluid leak probability level, and/or other fluid leak probability levels.

In some implementations, the multiple sensors of the different types may include one or more infrared image sensor, one or more sound sensors, and/or other sensors. In some implementations, the multiple sensors of the different types may include multiple infrared image sensors of different types.

The reconciliation component may be configured to reconcile different fluid leak probability levels detected by different ones of the multiple sensors. Different fluid leak probability levels detected by different ones of the multiple sensors may be reconciled using a Bayesian model. The Bayesian model may determine likelihoods of multiple fluid leak probability levels at the location based on the separate fluid leak probability levels detected at the location by the multiple sensors and/or other information.

In some implementations, the multiple fluid leak probability levels for which the Bayesian model determines the likelihoods include a first fluid leak probability level, a second fluid leak probability level, and/or other fluid leak probability levels.

The operation component may be configured to facilitate one or more operations at the fluid facility based on the likelihoods of the multiple fluid leak probability levels at the location and/or other information.

In some implementations, the facilitation of the operation(s) at the fluid facility based on the likelihoods of the multiple fluid leak probability levels at the location may include generation of one or more alerts based on a determination that the location includes the fluid leak and/or other information.

In some implementations, facilitation of the operation(s) at the fluid facility based on the likelihoods of the multiple fluid leak probability levels at the location may include determination of whether the location includes a fluid leak based on highest of the likelihoods of multiple fluid leak probability levels at the location and/or other information. In some implementations, the determination of whether the location includes the fluid leak based on the highest of the likelihoods of multiple fluid leak probability levels at the location may be confirmed or invalidated based on observation made by one or more other sensors different from the multiple sensors and/or other information.

In some implementations, facilitation of the operation(s) at the fluid facility based on the likelihoods of the multiple fluid leak probability levels at the location may include determination of one or more hole sizes for the fluid leak based on sound captured at the location, pressure of equipment at the location, and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for detecting fluid leaks.

FIG. 2 illustrates an example method for detecting fluid leaks.

FIG. 3 illustrates an example diagram of aggregation and distribution of sensor observations for fluid leak detection.

FIG. 4 illustrates an example Bayesian model diagram.

FIG. 5 illustrates an example probability table for a Bayesian model.

### DETAILED DESCRIPTION

The present disclosure relates to detecting fluid leaks. Fluid leak observations made by different types of sensors are combined to detect fluid leaks at a fluid facility. Separate fluid leak observations made by different types of sensors are reconciled using a Bayesian model. The Bayesian model outputs likelihoods of different fluid leak probabilities, and the likelihoods of different fluid leak probabilities are used to facilitate operations at the fluid facility

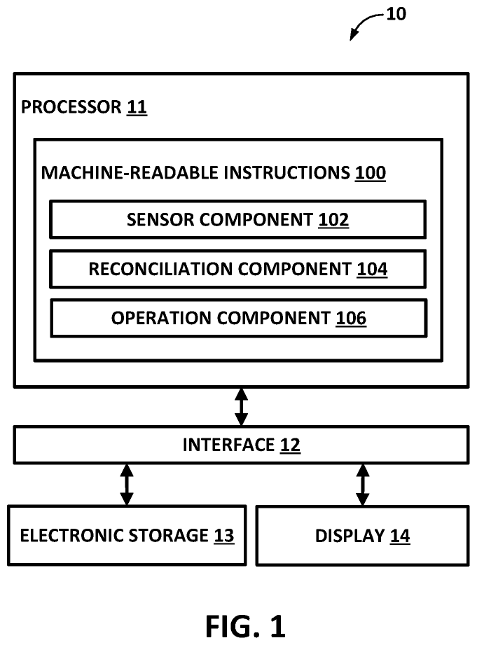

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Multi-sensor information and/or other information may be obtained by the processor 11. The multi-sensor information may characterize separate fluid leak probability levels detected at a location by multiple sensors of different types for a fluid facility. The multiple sensors of the different types may include a first sensor of a first type, a second sensor of a second type different from the first type, and/or other sensors of other types. The muti-sensor information may characterize a first fluid leak probability level detected at the location by the first sensor of the first type, a second fluid leak probability level detected at the location by the second sensor of the second type, and/or other fluid leak probability levels detected at the location by sensors of other types. Different fluid leak probability levels detected by different ones of the multiple sensors may be reconciled by the processor 11 using a Bayesian model. The Bayesian model may determine likelihoods of multiple fluid leak probability levels at the location based on the separate fluid leak probability levels detected at the location by the multiple sensors and/or other information. One or more operations at the fluid facility may be facilitated by the processor 11 based on the likelihoods of the multiple fluid leak probability levels at the location and/or other information.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store multi-sensor information, information relating to sensors, information relating to sensor types, information relating to a fluid facility, information relating to a location at the fluid facility, information relating to fluid, information relating to fluid leaks, information relating to operations at the fluid facility, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present multi-sensor information, information relating to sensors, information relating to sensor types, information relating to a fluid facility, information relating to a location at the fluid facility, information relating to fluid, information relating to fluid leaks, information relating to operations at the fluid facility, and/or other information.

A fluid facility may refer to a facility (e.g., place, equipment, etc.) that generates, processes, stores, transports, and/or otherwise operates on fluid. Fluid may refer to substance that has no fixed shape. Fluid may refer to substance that yields easily to external pressure. Fluid may be composed of a single type of substance or multiple types of substance. Fluid may exist in one or more forms, such as liquid and/or gas. Examples of fluid include hydrocarbon gas, hydrocarbon liquid, water, wastewater, and chemical. Examples of liquid include crude gasoline, raw pyrolysis gasoline, diesel fuel, jet fuel, produced water, liquid propane, tailings, ethylene, propylene, liquid carbon dioxide, natural gas liquids, and gas condensate. Examples of gas include natural gas, hydrogen, hydrogen sulfide, nitrogen, carbon dioxide, and methane. Other types of fluid are contemplated.

A fluid leak may refer to fluid escaping from a fluid facility. A fluid leak may include a gas leak and/or a liquid leak. A fluid leak may refer to fluid escaping from equipment at a fluid facility. For example, a fluid leak may refer to fluid escaping from pipes, containers, and/or other equipment that generates, processes, stores, transports, and/or otherwise operates on the fluid. Fluid leaks at fluid facilities may cause damage to the fluid facilities, cause damage to surrounding areas, disrupt fluid facility operations (e.g., cause production disruptions), pose safety hazards, and/or cause other problems. It is critical to detect fluid leaks at fluid facilities. Detection of fluid leaks enable the fluid leaks to be stopped or fixed.

Present disclosure provides a tool to detect fluid leaks at fluid facilities using observations made by multiple types of sensors. Observations by different types of sensors provide separate fluid leak detections at a fluid facility, and different fluid leak detections from different types of sensors are reconciled using a Bayesian model. Reconciliation of the fluid leak detections from different types of sensors may result in more accurate detection of fluid leaks than relying on separately fluid leak detections from different types of sensors.

Fluid leak detections reconciled using the Bayesian model may be used to facilitate one or more operations at the facility. For example, the result of the fluid leak detection reconciliation may be presented to one or more persons at the fluid facility to facilitate operations at the fluid facility (e.g., stop/change operations to stop/change generation, processing, storage, and/or transportation of fluid; stop fluid leak; fix fluid leak). One or more operations at the facility may be automated based on the result of the fluid leak detection reconciliation. One or more alarms may be generated responsive to the result of the fluid leak detection reconciliation.

Present disclosure provides an integrated analytic platform that incorporates design information (e.g., engineering standards, specifications, guidelines, etc.), operational information (e.g., flow, temperature, pressure, vibration, etc.), environmental information (e.g., humidity, wind speed, solar radiation, air temperature, etc.), and maintenance information (e.g., inspections, operator routine duties, failure data, etc.) using diverse communications (e.g., WiFi, Cellular, Wired, etc.) and power methods (e.g., wired, battery, solar, wind, harnessed, etc.) for fluid leak detection and response.

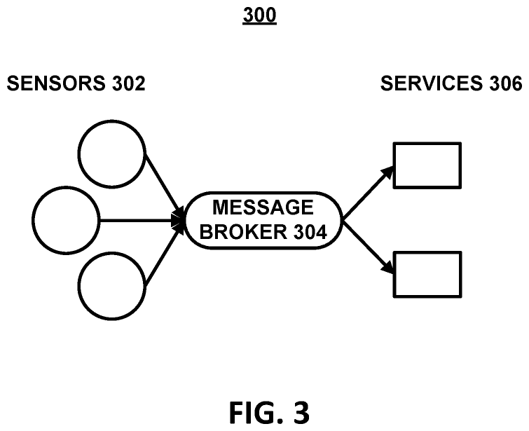

FIG. 3 illustrates an example diagram 300 of aggregation and distribution of sensor observations for fluid leak detection. Conditions at a fluid facility may be observed by multiple sensors 302 of different types (e.g., image sensor, infrared image sensor, sound sensor, point sensor, gas sensor, liquid sensor). Observations made by the multiple sensors 302 may include and/or be used to determine probability of a fluid leak at the fluid facility (e.g., probability percentage of the fluid leak, low probability of the fluid leak, medium probability of the fluid leak, high probability of the fluid leak). The observations made by the multiple sensors 302 may be aggregated at a message broker 304. A variety of communication methods/streaming protocols may be used to relay the observations from the multiple sensors 302 to the message broker 304.

Multiple services 306 may subscribe to one or more of the data streams provided by the message broker 304. The data streams may include sensor observations and/or results of analytics performed on the sensor observations. Different services 306 may subscribe to the same data stream(s) to receive same information from the message broker 304. Different services may subscribe to different data streams to receive different information from the message broker 304. One or more of the services 306 may use the information received through the data stream(s) to determine whether there is a fluid leak at the fluid facility.

For example, a service may include a Bayesian model that receives separate/different observations of fluid leak made by the sensors 302 and reconcile the separate/different observations to determine whether there is a fluid leak at a fluid facility. Detection of fluid leak may be confirmed or invalidated based on observations made by other sensors (e.g., vibration sensor, point sensor). Additional analysis may be performed for the fluid leak, such as to quantify the fluid leak (e.g., the rate of the fluid leak, how much fluid has been leaked), locate the fluid leak (e.g., GPS location of the fluid leak), and/or determine source of the fluid leak (e.g., equipment where the fluid leak is happening, size of hole through which fluid is leaking). The fluid leak detection and/or the results of the analysis (along with confidence/accuracy of the fluid leak detection and/or the results of the analysis) may be provided to one or more persons at the fluid facility to facilitate operations at the fluid facility. For example, an alert may be generated based on detection of the fluid leak and/or information about the fluid leak may be presented on one or more displays. Analysis of the sensor observations may be performed locally at the sensors 302 (e.g., by the sensors 302, by computing device(s) coupled to the sensors 302) and/or performed remotely from the sensors 302 (e.g., server(s), edge device(s), computing device(s) communicatively coupled to the message broker 304/services 306).

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate detecting fluid leaks. The machine-readable instructions 100 may include one or more computer program components. The machine-readable instructions 100 may include one or more of a sensor component 102, a reconciliation component 104, an operation component 106, and/or other computer program components.

The sensor component 102 may be configured to obtain multi-sensor information and/or other information. Obtaining multi-sensor information may include one or more of accessing, acquiring, analyzing, determining, examining, generating, identifying, loading, locating, measuring, opening, receiving, retrieving, reviewing, selecting, storing, and/or otherwise obtaining the multi-sensor information. The sensor component 102 may obtain multi-sensor information from one or more locations. For example, the sensor component 102 may obtain multi-sensor information from a storage location, such as the electronic storage 13, electronic storage of a device accessible via a network, and/or other locations. The sensor component 102 may obtain multi-sensor information from one or more hardware components (e.g., a computing device, sensors) and/or one or more software components (e.g., software running on a computing device, software running on sensors).

The multi-sensor information may characterize separate fluid leak probability levels detected at a location by multiple sensors of different types for a fluid facility. The fluid facility may include multiple sensors of different types to observe conditions at a location within the fluid facility. Different types of sensors may be used to observe conditions at the location to detect fluid leaks at the locations. Example types of sensors deployed at the fluid facility to detect fluid leak probability levels may include image sensor, infrared image sensor, sound sensor, and/or other types of sensors. The multiple sensors of different types may include one or multiple sensors of the same type. For example, conditions at a location within a fluid facility may be observed by one or more infrared image sensor, one or more sound sensors, and/or other sensors to detect fluid leak probability levels. Multiple infrared image sensors of the same type or different types may be deployed at the location. The muti-sensor information may characterize separate fluid leak probability levels detected at the location by the infrared image sensor(s), the sound sensor(s), and/or other sensors.

Other types of sensors may be deployed at the fluid facility. Othe types of sensors may be deployed to confirm or invalidate observations made by the multiple sensors of different types that detect fluid leak probability levels. Other types of sensors may include point sensor (e.g., hydrocarbon isotope point sensor, polymer absorption sensor), gas sensor, liquid sensor, methane sensor, hydrocarbon sensor, fiber optic sensor, vibration sensor, pressure sensor, temperature sensor, weather sensor, flow sensor, and/or other sensors. For example, point sensor and/or gas sensor may be deployed to confirm or invalidate observations made by infrared image sensor(s) and/or sound sensor(s). Other combinations of sensors are contemplated.

A fluid leak probability level detected at a location by a sensor may refer to measurement by the sensor of the probability that the location has a fluid leak. A fluid leak probability level may include quantification, classification, and/or other reflection of the probability measured by the sensor that the location has a fluid leak. For example, a fluid leak probability level may include a percentage value that reflects the probability percentage/confidence score of a fluid leak at the location. As another example, a fluid leak probability level may include different classification levels, such as a first fluid leak probability level, a second fluid leak probability level, and/or other fluid leak probability levels (e.g., a high fluid leak probability level, a medium fluid leak probability level, a low fluid leak probability level, etc.). In some implementations, the percentage value of the fluid leak determined by a sensor may be classified into a particular level (e.g., 5% fluid leak probability being classified as a low fluid leak probability level). Other types of fluid leak probability level are contemplated.

The multi-sensor information may characterize a fluid leak probability level detected at a location by a sensor by defining, describing, identifying, quantifying, reflecting, setting forth, and/or otherwise characterizing one or more of value, property, quality, quantity, attribute, feature, and/or other aspects of the fluid leak probability level. For example, the multi-sensor information may specify value(s) that make up/define the fluid leak probability level detected at the location by the sensor and/or include information from which the fluid leak probability level may be determined (e.g., calculated). Other types of multi-sensor information are contemplated.

The reconciliation component 104 may be configured to reconcile different fluid leak probability levels detected by different sensors. Different fluid leak probability levels detected by different sensors may be reconciled using a Bayesian model. Reconciling different fluid leak probability levels detected by different sensors may include reconciling different fluid leak probability levels detected by sensors of different types (e.g., different fluid leak probability levels detected by an infrared image sensor and a sound sensor at a location) and/or reconciling different fluid leak probability levels detected by multiple sensors of the same type (e.g., different fluid leak probability levels detected by multiple infrared image sensors at a location). Reconciling different fluid leak probability levels detected by different sensors may include settling differences between the different fluid leak probability levels detected by different sensors. Reconciling different fluid leak probability levels detected by different sensors may include combining the different fluid leak probability levels detected by different sensors.

The Bayesian model may refer to a statistical model in which probabilities are used to represent uncertainties. A Bayesian model may make inference based on Bayes theorem. The Bayesian model may reconcile different fluid leak probability levels detected by different sensors by determining likelihoods of the different fluid leak probability levels. Likelihoods of multiple fluid leak probability levels at the location may be determine based on the separate fluid leak probability levels detected at the location by the multiple sensors and/or other information. The Bayesian model may receive as input the separate fluid leak probability levels detected by the sensors and output likelihood of different fluid leak probability levels.

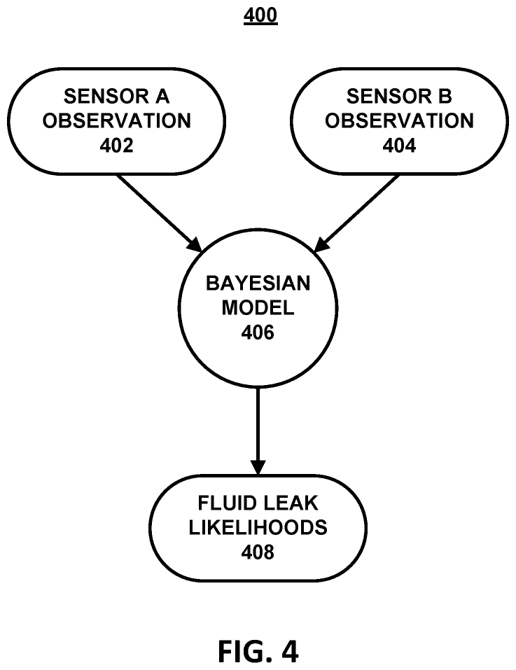

FIG. 4 illustrates an example Bayesian model diagram 400. Inputs to a Bayesian model 406 may include a sensor A observation 402 (e.g., fluid leak probability level detected by a sensor, measurements made by a sensor from which fluid leak probability level is determined) and a sensor B observation 404 (e.g., fluid leak probability level detected by another sensor, measurements made by the other sensor from which fluid leak probability level is determined). The sensor A observation 402 may be different from the sensor B observation 404. The Bayesian model 406 may reconcile the differences between the sensor A observation 402 and the sensor B observation 404, and output fluid leak likelihoods 408 (e.g., likelihoods of different fluid leak probability levels). For example, the inputs into the Bayesian model 406 may include probability percentages of the fluid leak detected by different sensors. The probability percentages may be converted into classification/groups, such as a first fluid leak probability level, a second fluid leak probability level, and/or other fluid leak probability levels (e.g., low fluid leak probability, medium fluid leak probability, and a high fluid leak probability). The Bayesian model 406 may output likelihoods of the different probabilities. That is, the Bayesian model 406 may output probabilities of the different probabilities: probability of the first fluid leak probability being correct; probability of the second fluid leak probability being correct; and probability of other fluid leak probability being correct.

The operation/rules of the Bayesian model may be defined by one or more probability tables. A probability table may define outputs of the Bayesian model based on different combinations of inputs to the Bayesian model. For different combinations of fluid leak probability level values, the probability table may define likelihoods of the different fluid leak probability levels.

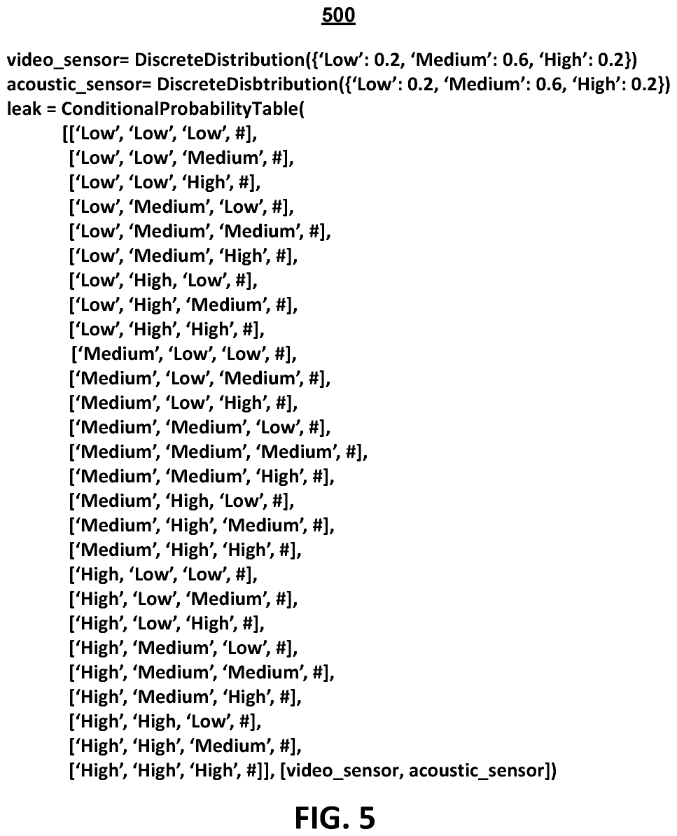

FIG. 5 illustrates an example probability table 500 for a Bayesian model. The probability table 500 may define outputs of a Bayesian model based on different combinations of inputs that include observations made by an image sensor (video sensor) and a sound sensor (acoustic sensor). Inputs into the Bayesian model may include fluid leak probability values (between 0 and 1) detected by the image sensor and the sound sensor. Values between 0 and 0.2 may be classified as low fluid leak probability, values between 0.2 and 0.8 may be classified as medium fluid leak probability, and values between 0.8 and 1 may be classified as high fluid leak probability.

For different combinations of fluid leak probability observed by the two sensors, the probability table 500 may define the likelihood of low fluid leak probability being correct, the likelihood of medium fluid leak probability being correct, and the likelihood of high fluid leak probability being correct. The probability table 500 may define values of the low, medium, and high fluid leak probability being correct for different combinations of fluid leak probability observed by the different sensors. The values assigned to different combinations of fluid leak probability may be determined based on determined based on historical fluid leaks (e.g., actual fluid leaks, fluid leak tests). Sensor observations for different fluid leaks may be measured and used to tune the values assigned to different combinations of fluid leak probability. The output of the Bayesian model may include the likelihood of low fluid leak probability, the likelihood of medium fluid leak probability, and the likelihood of high fluid leak probability. Other information relating to the fluid leak may be output.

While FIG. 5 shows the probability table 500 defining the likelihood values for a high fluid leak probability level, a medium fluid leak probability level, a low fluid leak probability level, this is merely as an example and is not meant to be limiting. The Bayesian model may output likelihood for individual types of observations that may be made by a sensor. Other classification/grouping of fluid leak probability observations are contemplated.

In some implementations, the classification/grouping of fluid leak probability observations may be dynamic. In some implementations, the classification/grouping of fluid leak probability observations may be static. In some implementations, the classification/grouping of fluid leak probability observations may be defined/set by a user. In some implementations, the classification/grouping of fluid leak probability observations may be defined/set based on distributions of the fluid leak probability observations. For example, the number of classification/grouping and/or the values that fall within different classification/group may be determined based on desired values and/or corresponding distribution.

For instance, the fluid leak probability observations may be separated into three different groups (e.g., low fluid leak probability level, medium fluid leak probability level, and a high fluid leak probability level). The fluid leak probability observations that fall within the first group (e.g., low fluid leak probability level) may be set so that the first group includes fluid leak probability observations less than 30%. The fluid leak probability observations that fall within second first group (e.g., medium fluid leak probability level) may be set so that the second group includes fluid leak probability observations between 30% and 90%. The fluid leak probability observations that fall within the third group (e.g., high fluid leak probability level) may be set so that the third group includes fluid leak probability observations greater than 90%. Other numbers of classification/grouping of fluid leak probability observations and other ranges of fluid leak probability observations within classification/grouping are contemplated.

Other information may be input into the Bayesian model to affect the probability likelihood determination. For example, in additional to observations made by different types of sensors, information about the fluid facility and/or the environment may be used as input to the Bayesian model. For instance, type, design, age, maintenance, inspection, and/or operation of equipment at the fluid facility may affect the probability that a fluid leak will occur at the facility. Information about the type, design, age, maintenance, inspection, and/or operation of equipment at the fluid facility may be obtained and used as input to the Bayesian model to determine the likelihoods of different fluid leak probabilities.

The operation component 106 may be configured to facilitate one or more operations at the fluid facility based on the likelihoods of the multiple fluid leak probability levels at the location and/or other information. Facilitating an operation at the fluid facility may include enabling/assisting in preparation, planning, and/or performance of the operation at the fluid facility. Facilitating an operation at the fluid facility based on the likelihoods of the multiple fluid leak probability levels at the location may include providing (e.g., presenting on a display, generating a message) information relating to the likelihoods of the multiple fluid leak probability levels at the location to one or more persons at the fluid facility and/or one or more persons working on operations at the fluid facility. Facilitating an operation at the fluid facility based on the likelihoods of the multiple fluid leak probability levels at the location may include automating one or more operations at the fluid facility (e.g., stop/change operations to stop/change generation, processing, storage, and/or transportation of fluid; stop fluid leak; fix fluid leak) based on information relating to the likelihoods of the multiple fluid leak probability levels at the location. Other facilitations of operations are contemplated.

In some implementations, the facilitation of the operation(s) at the fluid facility based on the likelihoods of the multiple fluid leak probability levels at the location may include determination of whether the location includes a fluid leak (fluid leak detection) based on the likelihoods of the multiple fluid leak probability levels at the location and/or other information. Whether the location includes a fluid leak may be determined based on values of the likelihoods of the multiple fluid leak probability levels at the location.

For example, whether the location includes a fluid leak may be determined based on the highest of the likelihoods of multiple fluid leak probability levels at the location. The highest value among the likelihoods of multiple fluid leak probability levels may be assigned as the fluid leak probability value at the location, this value may be compared to a threshold value to determine whether there is a fluid leak at the location. For example, the Bayesian model may output the likelihood of a high fluid leak probability level as being 4%, the likelihood of a medium fluid leak probability level as being 3.6%, and the likelihood of a low fluid leak probability level as being 0.4%. Based on these numbers, the likelihood of the location including a fluid leak may be set as 4%. The 4% may be compared to a threshold value to determine whether these is a fluid leak at the location. The 4% being larger (or being equal to) than the threshold value may result in determination that there is a fluid leak at the location while the 4% being smaller than the threshold value may result in determination that there is no fluid leak at the location.

As another example, whether the location includes a fluid leak may be determined based on comparison of individual likelihoods of multiple fluid leak probability levels at the location to one or more threshold values. The individual likelihoods of multiple fluid leak probability levels may be compared to the same threshold value (e.g., same threshold value for low, medium, and high fluid leak probability levels) or different threshold values (e.g., different threshold values for low, medium, and high fluid leak probability levels). In some implementations, the location may be determined to include a fluid leak based on at least one of the likelihoods of multiple fluid leak probability levels satisfying the threshold values (e.g., being greater than the threshold values, being same as the threshold values). In some implementations, the location may be determined to include a fluid leak based on multiples of the likelihoods of multiple fluid leak probability levels satisfying the threshold values. In some implementations, the location may be determined to include a fluid leak based on all of the likelihoods of multiple fluid leak probability levels satisfying the threshold values. In some implementations, the location may be determined to include a fluid leak based on majority of the likelihoods of multiple fluid leak probability levels satisfying the threshold values. Use of other logics to determine a fluid leak based on the likelihoods of the multiple fluid leak probability levels at the location is contemplated.

In some implementations, the determination of whether the location includes the fluid leak based on the likelihoods of multiple fluid leak probability levels at the location (e.g., based individual, multiple, or the highest of the likelihoods of multiple fluid leak probability levels) may be confirmed or invalidated. Confirmation or invalidation of the fluid leak detection may be performed based on observation made by one or more other sensors different from the multiple sensors that provide observations for the Bayesian model, and/or other information.

Sensors used to confirm/invalidate fluid leak detection may include point sensor (e.g., hydrocarbon isotope point sensor, polymer absorption sensor), gas sensor, liquid sensor, methane sensor, hydrocarbon sensor, fiber optic sensor, vibration sensor, pressure sensor, temperature sensor, weather sensor, flow sensor, and/or other sensors. For example, point sensor and/or gas sensor may be deployed to confirm or invalidate observations made by infrared image sensor(s) and/or sound sensor(s).

For example, vibration of equipment at the facility may cause noise, which may be falsely detected as the sound of a fluid leak. Observations from the vibration sensor(s) at the facility may be used to determine whether the equipment is vibrating at resonant frequency, which may result in generation of audible noise from the vibration. Detecting of equipment vibrating at resonant frequency may be used to invalidate fluid leak detection from sound sensor observations.

As another example, material detection sensors, such as liquid sensor, gas sensor, or point sensor, may be placed in strategic locations at the fluid facility. Costs of these sensors may make it impractical to place these sensors to cover all areas of the fluid facility. Material detection sensors at certain locations (e.g., locations that collect leaked fluid, locations to which leaks fluids are likely to travel) may be used to determine whether the location actually includes the leaked fluid. Fluid leak detection may be confirmed based on the material detection sensors detecting the leaked fluid. Fluid leak detection may be invalidated based on the material detection sensors not detecting the leaked fluid.

As yet another example, operating parameters of the fluid facility may be used to determine a fluid leak can exist at the location. For instance, measurement of consistent pressure/flow in the equipment at the location (e.g., no change in pressure/flow, change in pressure/flow below a threshold value) before and after fluid leak detection may indicate that there is no fluid leak at the location and the fluid leak detection may be invalidated. Change in pressure/flow in the equipment at the location before and after fluid leak detection may indicate that there is fluid leak at the location and the fluid leak detection may be confirmed. Additionally, status of equipment at the location may be used to determine whether there can be fluid leak at the location. For example, if the equipment at the location is not pressurized, then fluid leak at the location is not likely to occur and the fluid leak detection may be invalidated. Similarly, if the values at the location are closed to prevent movement of fluid, then fluid leak at the location is not likely to occur and the fluid leak detection may be invalidated.

In some implementations, rather than use observations by the other sensors in a separate confirmation/invalidation step, the observations by these other sensors may be provided as input into the Bayesian model. That is, rather than using these sensor observations after the Bayesian model analysis to confirm or invalidate the fluid leak detection (from the results of the Bayesian model analysis), the sensor observations may be input into the Bayesian model as part of the analysis in determining the likelihoods of multiple fluid leak probability levels, which may then be used to determine whether there is or is not a fluid leak at the location.

In some implementations, the facilitation of the operation(s) at the fluid facility based on the likelihoods of the multiple fluid leak probability levels at the location may include generation of one or more alerts (alarm(s)) based on a determination that the location includes the fluid leak and/or other information. A alert may include an audible alert, a visual alert, a haptic alert, and/or other alert. The alert may include information about the fluid leak, such as the location of the fluid leak, the timing of the fluid leak, the equipment associated with the fluid leak, and/or the type of fluid in the fluid leak.

In some implementations, the facilitation of the operation(s) at the fluid facility based on the likelihoods of the multiple fluid leak probability levels at the location may include quantifying the fluid leak. Quantification of the fluid leak may include determining the rate at which fluid is being leaked, the total amount of the fluid leak, and/or other quantification of the fluid leak. The fluid leak may be quantified based on sensor observations and/or other information. For example, the fluid leak may be quantified based on operating parameters of the equipment at the location, infrared images captured by infrared image sensor(s), sound captured by sound sensor(s), weather conditions reported by weather sensor(s) and/or other information.

In some implementations, facilitation of the operation(s) at the fluid facility based on the likelihoods of the multiple fluid leak probability levels at the location may include determination of one or more hole sizes for the fluid leak. The fluid may be leaking through the hole(s) in the equipment (e.g., hole(s) in a pipe, container), and the size of the hole(s) in the equipment may be determined based on sound captured at the location, pressure of equipment at the location, and/or other information. For example, fast Fourier transform may be applied to the sound captured at the location to calculate the frequency and amplitude of peaks in the sound. The frequency and amplitude of peaks in the sound, along with the pressure of the equipment, may be used to estimate the size of the hole(s) in the equipment. Other information, such as dimensions of the equipment (e.g., pipe diameter) and images of the location/equipment, may also be used to determine the size of the hole(s).

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

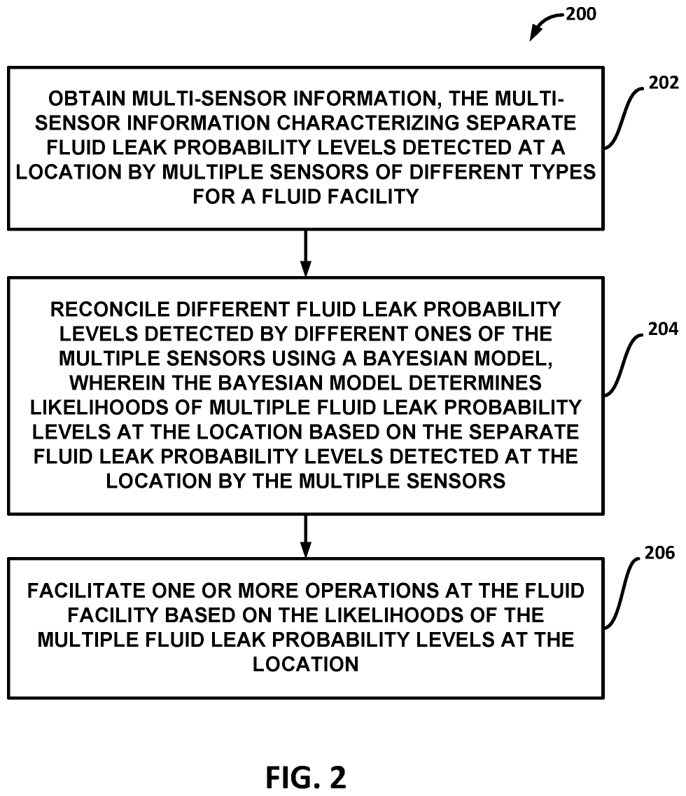

FIG. 2 illustrates method 200 for detecting fluid leaks. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, multi-sensor information and/or other information may be obtained. The multi-sensor information may characterize separate fluid leak probability levels detected at a location by multiple sensors of different types for a fluid facility. The multiple sensors of the different types may include a first sensor of a first type, a second sensor of a second type different from the first type, and/or other sensors of other types. The muti-sensor information may characterize a first fluid leak probability level detected at the location by the first sensor of the first type, a second fluid leak probability level detected at the location by the second sensor of the second type, and/or other fluid leak probability levels detected at the location by sensors of other types. In some implementations, operation 202 may be performed by a processor component the same as or similar to the sensor component 102 (Shown in FIG. 1 and described herein).

At operation 204, different fluid leak probability levels detected by different ones of the multiple sensors may be reconciled using a Bayesian model. The Bayesian model may determine likelihoods of multiple fluid leak probability levels at the location based on the separate fluid leak probability levels detected at the location by the multiple sensors and/or other information. In some implementations, operation 204 may be performed by a processor component the same as or similar to the reconciliation component 104 (Shown in FIG. 1 and described herein).

At operation 206, one or more operations at the fluid facility may be facilitated based on the likelihoods of the multiple fluid leak probability levels at the location and/or other information. In some implementations, operation 206 may be performed by a processor component the same as or similar to the operation component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for detecting fluid leaks, the system comprising:
one or more physical processors configured by machine-readable instructions to:
obtain multi-sensor information, the multi-sensor information characterizing separate fluid leak probability levels detected at a location by multiple sensors of different types for a fluid facility, the multiple sensors of the different types including a first sensor of a first type and a second sensor of a second type different from the first type, the muti-sensor information characterizing a first fluid leak probability level detected at the location by the first sensor of the first type and a second fluid leak probability level detected at the location by the second sensor of the second type;
reconcile different fluid leak probability levels detected by different ones of the multiple sensors using a Bayesian model, wherein the Bayesian model determines likelihoods of multiple fluid leak probability levels at the location based on the separate fluid leak probability levels detected at the location by the multiple sensors; and
facilitate one or more operations at the fluid facility based on the likelihoods of the multiple fluid leak probability levels at the location.

2. The system of claim 1, wherein the multiple sensors of the different types include an infrared image sensor and a sound sensor.

3. The system of claim 2, wherein the multiple sensors of the different types further include multiple infrared image sensors of different types.

4. The system of claim 1, wherein the facilitation of the one or more operations at the fluid facility based on the likelihoods of the multiple fluid leak probability levels at the location includes generation of an alert based on a determination that the location includes the fluid leak.

5. The system of claim 1, wherein facilitation of the one or more operations at the fluid facility based on the likelihoods of the multiple fluid leak probability levels at the location includes determination of whether the location includes a fluid leak based on highest of the likelihoods of multiple fluid leak probability levels at the location.

6. The system of claim 5, wherein the determination of whether the location includes the fluid leak based on the highest of the likelihoods of multiple fluid leak probability levels at the location is confirmed or invalidated based on observation made by one or more other sensors different from the multiple sensors.

7. The system of claim 1, wherein facilitation of the one or more operations at the fluid facility based on the likelihoods of the multiple fluid leak probability levels at the location includes determination of a hole size for the fluid leak based on sound captured at the location and pressure of equipment at the location.

8. The system of claim 1, wherein the separate fluid leak probability levels detected at the location by the multiple sensors include a first fluid leak probability level and a second fluid leak probability level.

9. The system of claim 1, wherein the multiple fluid leak probability levels for which the Bayesian model determines the likelihoods include a first fluid leak probability level and a second fluid leak probability level.

10. The system of claim 1, wherein the fluid leak includes a gas leak or a liquid leak.

11. A method for detecting fluid leaks, the method comprising:
obtaining multi-sensor information, the multi-sensor information characterizing separate fluid leak probability levels detected at a location by multiple sensors of different types for a fluid facility, the multiple sensors of the different types including a first sensor of a first type and a second sensor of a second type different from the first type, the muti-sensor information characterizing a first fluid leak probability level detected at the location by the first sensor of the first type and a second fluid leak probability level detected at the location by the second sensor of the second type;
reconciling different fluid leak probability levels detected by different ones of the multiple sensors using a Bayesian model, wherein the Bayesian model determines likelihoods of multiple fluid leak probability levels at the location based on the separate fluid leak probability levels detected at the location by the multiple sensors; and
facilitating one or more operations at the fluid facility based on the likelihoods of the multiple fluid leak probability levels at the location.

12. The method of claim 11, wherein the multiple sensors of the different types include an infrared image sensor and a sound sensor.

13. The method of claim 12, wherein the multiple sensors of the different types further include multiple infrared image sensors of different types.

14. The method of claim 11, wherein facilitating the one or more operations at the fluid facility based on the likelihoods of the multiple fluid leak probability levels at the location includes generating an alert based on a determination that the location includes the fluid leak.

15. The method of claim 11, wherein facilitating the one or more operations at the fluid facility based on the likelihoods of the multiple fluid leak probability levels at the location includes determining whether the location includes a fluid leak based on highest of the likelihoods of multiple fluid leak probability levels at the location.

16. The method of claim 15, wherein determining whether the location includes the fluid leak based on the highest of the likelihoods of multiple fluid leak probability levels at the location includes confirmation or invalidation based on observation made by one or more other sensors different from the multiple sensors.

17. The method of claim 11, wherein facilitating the one or more operations at the fluid facility based on the likelihoods of the multiple fluid leak probability levels at the location includes determining a hole size for the fluid leak based on sound captured at the location and pressure of equipment at the location.

18. The method of claim 11, wherein the separate fluid leak probability levels detected at the location by the multiple sensors include a first fluid leak probability level and a second fluid leak probability level.

19. The method of claim 11, wherein the multiple fluid leak probability levels for which the Bayesian model determines the likelihoods include a first fluid leak probability level and a second fluid leak probability level.

20. The method of claim 11, wherein the fluid leak includes a gas leak or a liquid leak.
